(19) United States
(12) Patent Application Publication
(10) Pub. No.: US 2005/0179564 A1
(43) Pub. Date: Aug. 18, 2005

(54) Griffin 2.0

(75) Inventor: Jesse Frederick Leaman, Berkeley, CA (US)

Correspondence Address: Jesse Leaman, 2333 College Ave., #114A, Berkeley, CA, 94704, US

(73) Assignee: Jesse Frederick Leaman, Berkeley, CA (US)

(21) Appl. No.: 10/904,957

(22) Filed: Dec. 7, 2004

Related U.S. Application Data
(60) Provisional application No. 60/535,643, filed on Jan. 12, 2004.

(51) Int. Cl. B62M 1/14

(52) U.S. Cl. 340/932.2; 180/271; 701/301

(57) ABSTRACT

The Griffin 2.0 is a rearview monitor and computer system that has been adapted for motorized wheelchair users, providing safety, security, and independence without significantly increasing battery consumption, or obstructing daily living activities. Using state-of-the-art, wireless technology the Griffin 2.0 gives wheelchair users the luxury of working or playing literally anywhere their wheelchair can take them.

The Griffin 2.0 takes its inspiration from luxury vehicles that have rearview monitors and navigation systems, but what makes it unique is that this system has been modified and adapted for use on motorized wheelchairs.

The griffin 2.0 consists of.

(1)An LCD monitor which is capable of receiving an input from a PC, an analog video camera and an S-video component such as a DVD player.

(2)A lap-tray upon which the LCD monitor is mounted, which flips conveniently out of the way when the wheelchair user wants to transfer out of the chair.

(3)A converter box, which is mounted to the back of the chair, and converts from the standard wheelchair battery output to the voltages necessary to run the LCD monitor, the video camera, and the laptop.

(4)An analog video camera which is attached to the back of the wheelchair.

(5)A laptop of the user's choosing, but certain brands are better suited for voice activation, which is a necessity for wheelchair users with limited or no arm strength.

(6)push button switches to activate the monitor, camera and laptop, which again can be customized, and positioned according to each user's needs

1. The Griffin 2.0 is a device that will increase a motorized wheelchair user's safety, security, independence, and thus overall mental well-being. When used as a computer the Griffin 2.0 allows the user to work or play right from her chair without having to ask for anybody's assistance. This is especially significant for people with limited arm movement, who would take full advantage of voice activation. It also provides another safety blanket when combined with wireless technology, since e-mail or instant messaging can be used to call for help.

2. When used as a rearview monitor the Griffin 2.0 allows the user to safely back out of narrow, unfamiliar areas without bumping into people or inanimate objects. It also alerts the user to faster traffic from the rear such as runners, skateboarders, bicycles, or cars, and provides the peace of mind of having “eyes in the back of your head,” that only a person who is physically unable to turn around would fully appreciate.

3. Unlike some customized wheelchair attachments, the Griffin 2.0 is mountable on any motorized wheelchair, and only increases power consumption by approximately 15 percent.
